(19) United States
(12) Patent Application Publication
(10) Pub. No.: US 2010/0283280 A1
(43) Pub. Date: Nov. 11, 2010

(54) Vehicle Cargo Management System

(75) Inventors: Kelly Michael Kohlstrand, Wyandotte, MI (US); Dean Basil Foussianes, Birmingham, MI (US)

Correspondence Address: Kristy J. Downing, Esq., 39555 Orchard Hill Pl., 6th Fl., PMB No.: 6051, Novi, MI, 48375, US

(73) Assignee: Ford Global Technologies LLC

(21) Appl. No.: 12/463,986

(22) Filed: May 11, 2009

(51) Int. Cl. B62D 33/03; B62D 33/033

(52) U.S. Cl. 296/26.11; 296/180.1; 296/51

(57) ABSTRACT

The present disclosure relates to various cargo management systems that are compatible with vehicles having a cargo bed and tailgate. Systems provide flexible storage space for the vehicle both in the stowed and extended positions. The amount of secure space available in the cargo bed can be increased when the cargo management systems are in the extended position. The systems partially cover the cargo bed and/or tailgate thereby reducing turbulence at an end of the vehicle and improving vehicle fuel efficiency.

### TECHNICAL FIELD

The present disclosure relates to vehicle cargo management systems; more specifically, the present disclosure relates to cargo management systems for use with vehicles having a tailgate.

### BACKGROUND

Today greater demands are being placed on vehicles to accommodate the cargo needs of a vehicle owner. Trucks and some other vehicles, e.g., sport utility vehicles or all utility vehicles, include a cargo bed. Larger items can be placed on the cargo bed of the vehicle. Typically the cargo bed includes three rigid panels and a tailgate that selectively opens and closes.

Some contemporary trucks include bed extenders that gate in the contents of the cargo bed when the tailgate is open. One design includes a number of rails that rotate between the cargo bed and tailgate. Without an enclosed profile, however, the fuel efficiency of the truck is diminished as the rear end of the truck experiences greater turbulence. Moreover, this type of arrangement can be less secure than others because the rails do not provide a lockable storage area neither when the bed extender is in the stowed nor the extended configuration.

Therefore, it is desirable to have a cargo management system that is compatible with vehicles having a cargo bed that improves or sustains vehicle fuel efficiency even when in an extended position. Moreover, it is desirable to have a lockable cargo management system for the vehicle cargo bed.

### SUMMARY

The present inventions address one or more of the above-mentioned issues. Other features and/or advantages may become apparent from the description which follows.

Accordingly to one exemplary embodiment, a vehicle includes a cargo bed and a tailgate at one end of the cargo bed. The tailgate is configured to move between an opened position and a closed position. A cargo management system is configured to pivot between a stowed position and an extended position, the system includes: a first panel configured to at least partially cover the cargo bed when the cargo management system is in the stowed position, thereby improving vehicle fuel efficiency. When in the stowed position the cargo management system at least partially sits atop the cargo bed and when in the extended position the cargo management system at least partially sits atop the tailgate.

In another exemplary embodiment, a cargo management system for use with a vehicle having a cargo bed and tailgate is provided. The system includes a top panel configured to at least partially cover the cargo bed; two side panels positioned between the cargo bed and top panel. The side panels are configured to attach to the top panel. A rear panel is configured to selectively rotate with respect to the top panel. The cargo management system is configured to rotate between the cargo bed and the tailgate when the tailgate is down.

One of the benefits of the teachings provided in the present disclosure is that they provide for increased fuel efficiency of the vehicle when the tailgate is down or in an opened position.

Another benefit of the present cargo management systems is that they provide selectively lockable storage areas for the vehicle driver.

In the following description, certain aspects and embodiments will become evident. It should be understood that the invention, in its broadest sense, could be practiced without having one or more features of these aspects and embodiments. It should be understood that these aspects and embodiments are merely exemplary and explanatory and are not restrictive of the invention.

The invention will be explained in greater detail below by way of example with reference to the figures, in which the same references numbers are used in the figures for identical or essentially identical elements. The above features and advantages and other features and advantages of the present invention are readily apparent from the following detailed description of the best modes for carrying out the invention when taken in connection with the accompanying drawings. In the figures:

### BRIEF DESCRIPTION OF THE DRAWINGS

FIG. 1 is a side view of a vehicle compatible with cargo management systems according to several exemplary embodiments of the present inventions.

FIG. 2 is a side view of the cargo bed of FIG. 1 with the tailgate in an opened position.

FIG. 3 is a side view of the cargo bed of FIG. 1 with a cargo management system in an extended position.

FIG. 4 is a side view of the cargo management system of FIG. 3 in a stowed position.

FIG. 5 is a side view of the cargo management system of FIG. 3 shown pivoting towards another stowed position.

FIG. 6 is a side view of the cargo management system of FIG. 3 in another stowed position.

FIG. 7 is a perspective view of a cargo management system in a stowed position according to another exemplary embodiment of the present inventions.

FIG. 8 is a perspective view of the cargo management system of FIG. 7 with a rear panel rotated upward.

FIG. 9 is an end view of the cargo management system of FIG. 7 with the rear panel rotated downward.

FIG. 10 is an end view of the cargo management system of FIG. 7 with the rear panel rotated upward.

FIG. 11 is a side view of the cargo management system of FIG. 7 with one panel in an extended position.

FIG. 12 is a side view of the cargo management system of FIG. 7 with the rear panel rotated downward.

FIG. 13 is a side view of the cargo management system of FIG. 7 with a tailgate in a stowed position.

Although the following detailed description makes reference to illustrative embodiments, many alternatives, modifications, and variations thereof will be apparent to those skilled in the art. Accordingly, it is intended that the claimed subject matter be viewed broadly.

### DETAILED DESCRIPTION

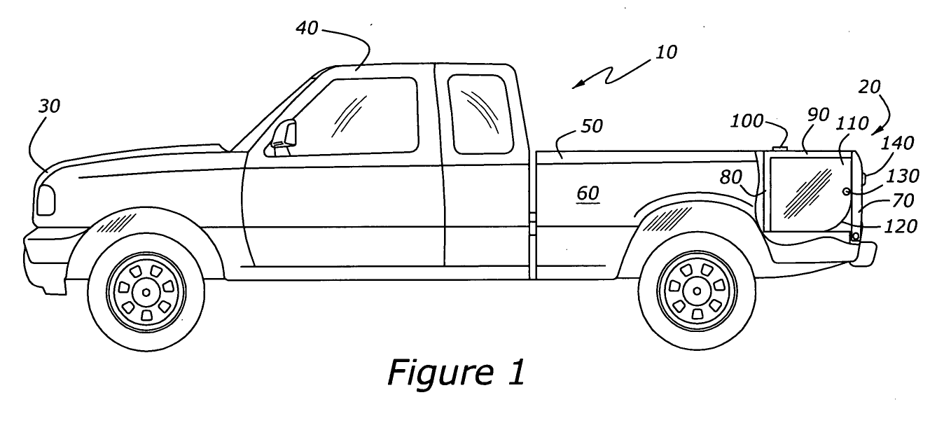

Referring to the drawings, FIGS. 1-13, wherein like characters represent the same or corresponding parts throughout the several views there is shown several exemplary vehicle cargo management systems. The cargo management systems are compatible with a vehicle cargo bed and tailgate. The cargo management systems can present better fuel economy and greater storage capabilities than contemporary arrangements. Cargo management systems are compatible with any type of automobile including e.g., pickup trucks, sports utility vehicles, and all utility vehicles.

With reference to FIG. 1, there is shown therein a side view of a pick-up truck 10 having a cargo management system 20 according to at least two exemplary embodiments of the present inventions. Shown in FIG. 1 are a front portion 30, passenger cabin 40 and cargo bed 50 of the truck 10. The cargo bed 50 is partially enclosed by three side panels (or walls) one of which 60 is shown in FIG. 1. A second panel, not shown, abuts the passenger cabin. The third panel, though not shown, is parallel to panel 60 and is substantially the same configuration as panel 60. In the shown embodiment, the cargo bed is approximately 5.5 feet long by 4 feet wide. In another embodiment, the passenger cabin 40 is extended and the cargo bed is shorter than 5.5 feet. Extended cargo beds, longer than 5.5 feet, are also compatible with cargo management system 20. Cargo bed 50 is further enclosed by a tailgate 70, as shown in FIG. 1 in the closed position or up. Tailgate 70 sits perpendicularly with respect to the cargo bed when the tailgate is in the closed position.

The truck 10 of FIG. 1 is compatible with the cargo management system 20. In the illustrated embodiment of FIG. 1 the cargo management system 20 is shown in a stowed position. In the stowed position the cargo management system 20 sits atop the vehicle cargo bed 50. The cargo management system 20 shares space with the cargo bed 50 when in the stowed position. Cargo management system 20 occupies approximately one third of the cargo bed 50 when in the stowed position. The system 20 is approximately 1.8 feet wide, along the length of the cargo bed, and just less than 4 feet along the width of the cargo bed. The cargo management system 20 includes four panels. Panel 80 is configured parallel with the tailgate 70 when the tailgate is in the closed position. Panel 80 is configured to rest flush with cargo bed 50 in this position to enclose the interior area of the cargo management system 20. Panel 90 is fixed perpendicularly with panel 80. Panel 90 provides a top surface, covering the interior area of the cargo management system 20. Panel 90 partially covers the cargo bed 50 when the system is in the stowed position. Panel 90 is not removable from the system 20. Panel 90 is fixed with respect to the cargo management system 20. Panel 80 is configured to selectively pivot open independently from panel 90. Panel 80 is hinged to panel 90 to enable access to the interior contents of the cargo management system 20. Panel 90 further includes a locking mechanism 100 to secure panel in place and preclude unwanted access into the interior of the cargo management system 20. Locking mechanism 100 can be any type of mechanical or electro-mechanical lock within the art. E.g., locking mechanism 100 can include a lock and key or an alpha-numeric keypad for selective entry.

The system of FIG. 1 further includes side panels, e.g., 110. Side panels 110 are positioned parallel with respect to each other and are of substantially the same configuration. Side panel 110 is attached to panel 80 at one edge and panel 90 at another edge. Panel 110 is configured to rotate or pivot with panels 80, 90. Side panels rotate with respect to the side panels of the cargo bed (e.g., 60) as the system moves between the stowed and extended positions. Side panel 110 includes a rounded corner 120 near the bottom of the panel. Rounded corner 120 provides several benefits to the cargo management system 20. Rounder corner 120 eases the rotation of the system with respect to the tailgate 70 and cargo bed 50. Rounded corner 120 also presents material cost savings. In the shown embodiment, corner 120 is rounded at an angle of 30 degrees. In other arrangements, corner 120 can be rounded at an angle that is greater than or less than 30 degrees. E.g., in one embodiment corners 120 are rounded at a 45 degree angle.

The side panel 110, as shown in FIG. 1, is pivotally attached to the side panels of the cargo bed, e.g. 60, at hinge 130. In the shown embodiment, the hinge 130 can be dampened using struts. Any type of hinge can be utilized to enable side panels 110 to pivot with respect to the cargo bed 50.

In this embodiment, panels 80, 90, and 110 are composed of a polymer (or hard plastic). Panels 80, 90, and 110 are formed via injection molding. Panels 80, 90, and 110 can be formed, e.g., using foam or gas molding or other comparable forming techniques in the art.

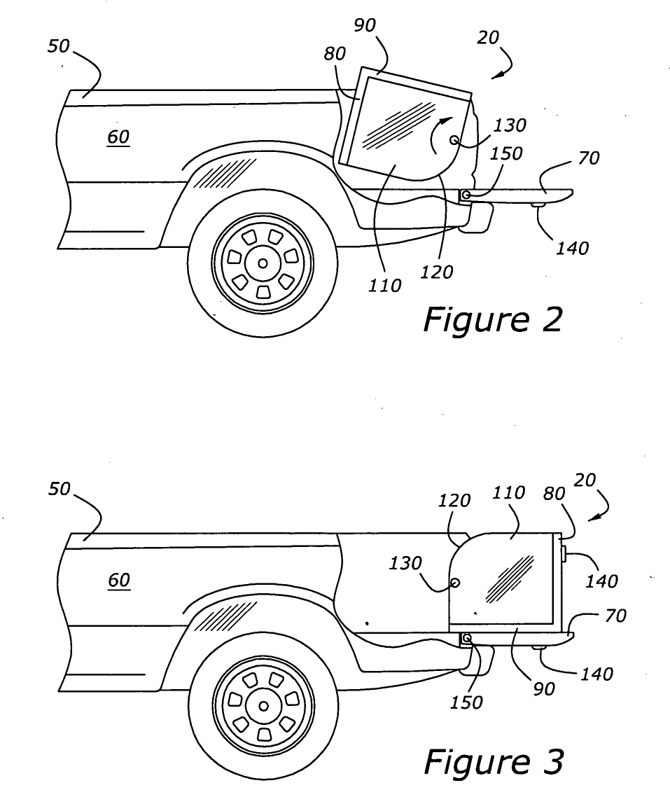

Turning now to FIG. 2, the cargo bed 50 is shown with the tailgate 70 down or in an opened position. Tailgate 70 sits perpendicularly with respect to the cargo bed 50 when the tailgate is in the closed position (as shown in FIG. 1) and parallel with the cargo bed when in the opened position. Tailgate 70 includes a locking mechanism 140. In the shown embodiment, the locking mechanism 140 is a lockable handle. Tailgate 70 is configured to pivot about hinge 150 of the cargo bed 50 into the opened position. When the tailgate 70 is in the opened position the contents of the cargo management system 20 can be accessed through the tailgate.

Cargo management system 20, as shown in FIG. 2, is configured to rotate about hinge 130. In the shown illustration, the system 20 is rotated approximately 20 degrees with respect to the cargo bed 50. Tailgate 70 is down or in an opened position. In the shown embodiment, the cargo management system 20 is not attached to the tailgate 70 when the tailgate is in the closed position and the system is stowed. Cargo management system 20 rotates substantially further than tailgate. E.g., while tailgate 70 rotates 90 degrees clockwise from the closed to opened position, the cargo management system 20 rotates 180 degrees clockwise from the stowed to the extended position. In other embodiments the cargo management system 20 rotates 90 degrees clockwise from the stowed to the extended position.

The cargo management system 20 is shown in an extended position in FIG. 3. The extended position is separated by approximately 180 degrees from the stowed position (as shown in FIG. 1). Cargo management 20 sits atop the tailgate 70 when in the extended position. Panel 90 is parallel with the tailgate 70 when the tailgate is in the opened position. Panel 80 is positioned perpendicularly with respect to the tailgate 70. Rounded corner 120 is repositioned into the top portion of the cargo bed 50. In this manner, the length of the cargo bed 50 of the truck is extendable by at least 1.8 feet.

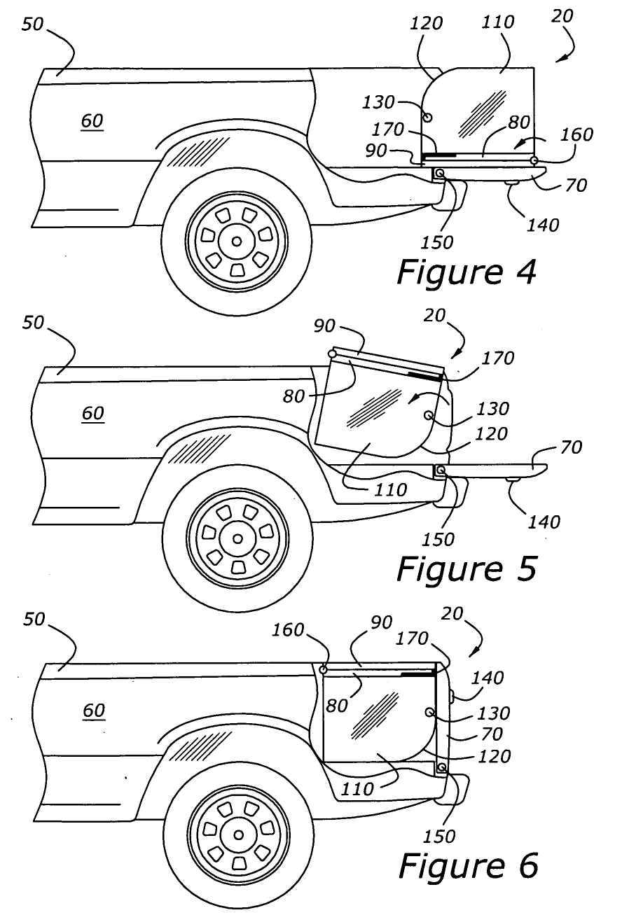

Referring now to FIGS. 4-6, cargo management system 20 is configured to achieve at least two additional stowed positions (as shown in FIGS. 4 and 6). Beginning with FIG. 4, there is shown a side view of the cargo bed 50 of FIG. 1 with the cargo management system 20 in another stowed position. When the tailgate 70 is down, panel 80 can be folded toward panel 90. Panel 80 is configured to pivot toward panel 90. Panel 90 is substantially parallel to the cargo bed 50 and tailgate 70. Panel 80 can change positions from being approximately perpendicular to panel 90 to abutting panel 90, being positioned substantially parallel to panel 90. In the shown embodiment, a hinge 160 is included at an end of panel 80 to enable panel 80 to pivot toward panel 90.

In one embodiment, as shown in FIGS. 4-6, panel 90 includes a latch 170 to secure panel 80 thereto when pivoted towards panel 90. Latch 170 is configured to secure panel 80 to panel 90. When latched together, panels 80 and 90 can rotate at least 180 with respect to the cargo bed 50. FIG. 5 shows panels 80, 90 pivoting or rotating from the stowed position of FIG. 4 to another stowed position (as shown in FIG. 6). Panels 80 and 90 are parallel with respect to each other, as shown in FIG. 5. Panels 80 and 90 are positioned at an angle of 20 degrees clockwise (or 160 degrees counterclockwise) with respect to the cargo bed 50. The cargo management system 20 is configured to pivot at least 180 degrees with tailgate 70 down or opened about hinge 130. FIG. 6 shows panels 80 and 90 rotated 180 degrees counterclockwise with respect to the cargo bed 50. Cargo bed 50 and panels 80, 90 are parallel. Panels 80, 90 at least partially cover the cargo bed 50, thereby providing reduced bed turbulence and improving fuel economy.

Referring now to FIGS. 7-13, there is another exemplary cargo management system 300 shown. The cargo management system 300 is configured to be attached to a vehicle cargo bed at an end with a tailgate. The cargo management system 300 is configured to act as a bed extender for the cargo bed. The system 300 can rotate between the cargo bed and tailgate when the tailgate is down, as shown e.g., with respect to FIG. 3. Cargo management system 300 provides additional coverage of the tailgate and support for cargo items when the tailgate is down.

In FIG. 7, the cargo management system 300 is shown in a stowed position and viewed from the perspective of being inside of the cargo bed looking toward the tailgate. System 300 includes four panels 310, 320, 330 and 340. In the shown embodiment, top panel 310 is partially covering the cargo bed 350. Top panel 310 is positioned parallel with respect to the cargo bed 350. Two side panels 320, 330 are included in the system; panels 320, 330 extend between the top panel 310 and the cargo bed 350. Side panels 320, 330 are attached to the top panel 310. Side panels 320, 330 include rounded corners 360, 370, respectively. Side panels 320, 330 are also selectively attached to the cargo bed 350. A rear panel 340 is also shown that is pivotally attached with respect to the top panel 310. Rear panel 340 is configured to rotate with respect to top panel 310.

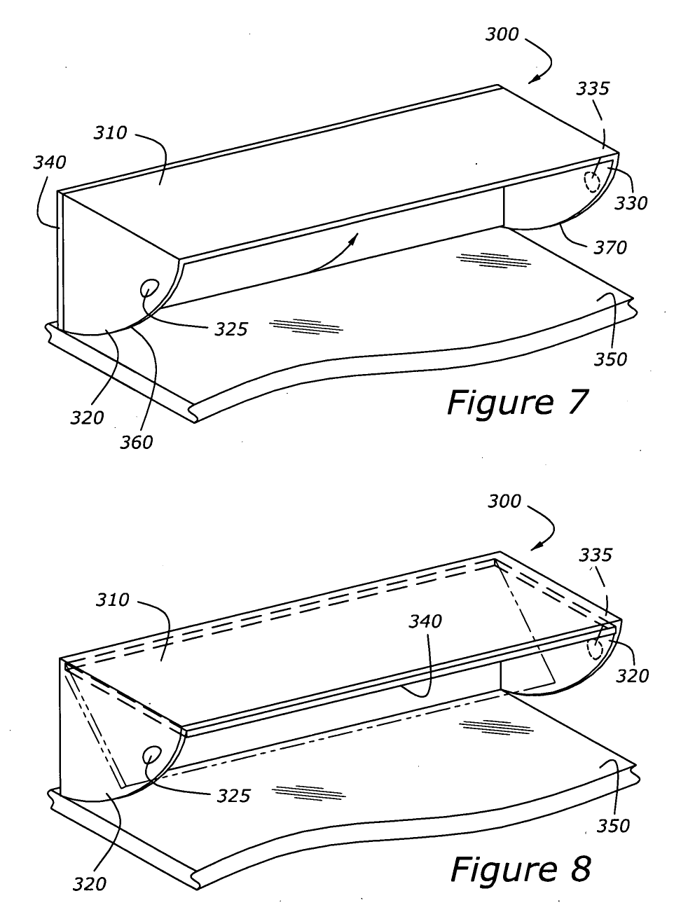

In FIG. 8, rear panel 340 is rotated approximately 45 degrees toward the top panel 310. Rear panel 340 can rotate into a position that is parallel with top panel 310 and latched or fastened thereto. Access to the tailgate is accordingly provided from the interior of the cargo bed 350 with the cargo management 300 system in the stowed position.

Side panels 320, 330, as shown in FIG. 8, are selectively attached to the cargo bed 350. Side panels 320, 330 further include release latches 325, 335 so that the cargo management system can be removed from the cargo bed. In the shown embodiment, release latches 325, 335 are spring mounted protrusions and are configured to engage at least one panel or surface in the cargo bed 350.

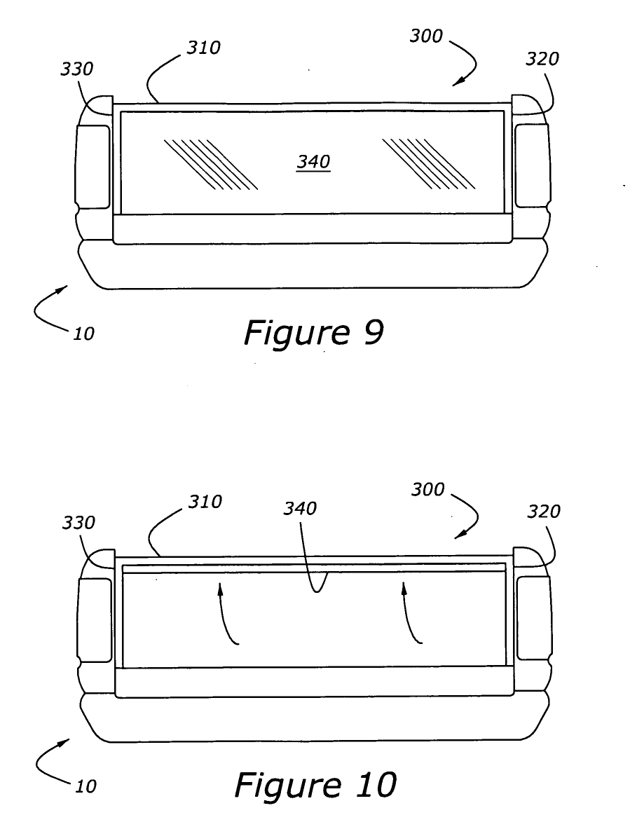

FIGS. 9 and 10, illustrate end views of the cargo management system 300 when the rear panel 340 is down and up, respectively. FIG. 9 shows the system with the rear panel 340 extended perpendicularly with respect to the top panel 310. FIG. 10 shows the rear panel 340 rotated toward the top panel 310. The cargo bed 350, as shown in FIGS. 7 and 8, is accessible from the rear of the vehicle when the tailgate is down or in an opened position.

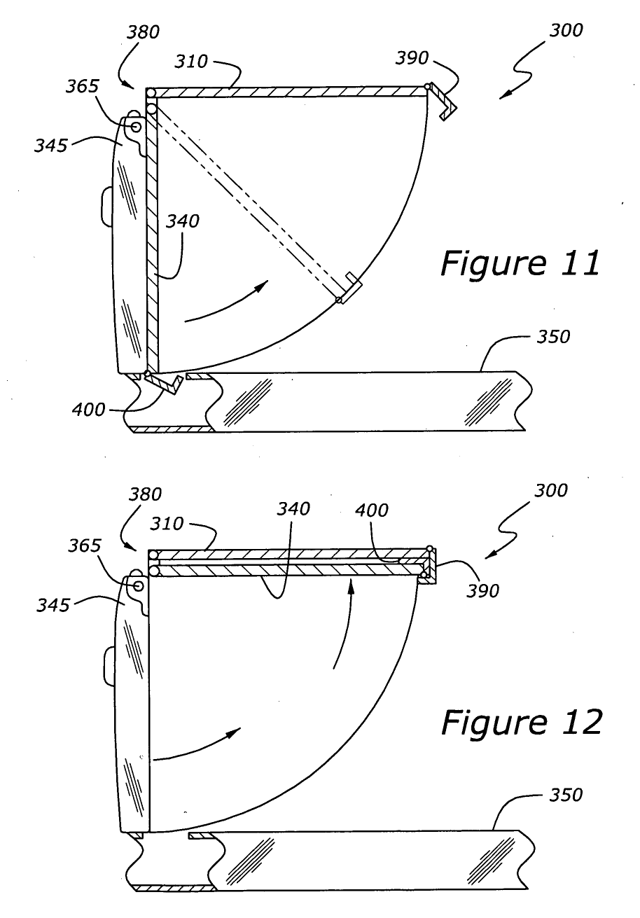

Referring now to FIGS. 11-13, rear panel 340 is hinged at 380 to pivot with respect to the top panel 310. In FIG. 11, panel 340 is shown down. Top panel 310 includes a latch 390. Latch 390 is configured to secure the panel 340 when rotated about hinge 380. A hinge 380 is included in each side panel (320, 330 as shown in FIGS. 5-8). Latch 390 is releasable (as shown in FIG. 11) to enable panel 340 to pivot downward or perpendicularly with respect to the cargo bed.

Top panel 310 is also configured to pivot or rotate with respect to the cargo bed 350. Side panels 320, 330 include a hinge comparable to hinge 380. Top panel 310 can selectively rotate into an opened and closed position to enable access to the interior of the cargo management system. Rear panel 340 includes a latch 400 (as shown in FIG. 12) to secure the top panel 310 to rear panel when the top panel is rotated downward. In one embodiment, top panel 310 includes a locking mechanism (e.g., 100 as shown with respect to the cargo management system 20 of FIG. 1) to secure top panel 310 with respect to the side panels 320, 330.

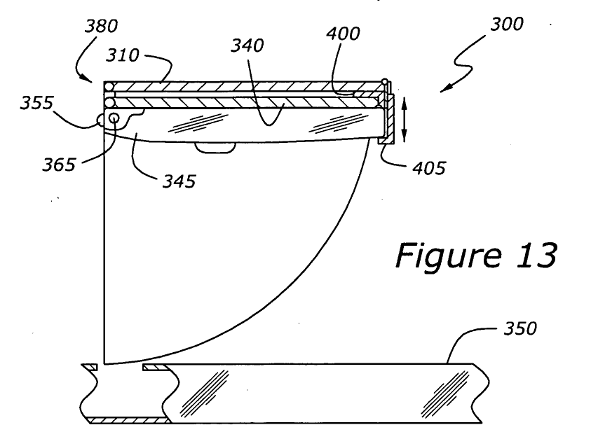

In one embodiment, as shown in FIG. 13, rear panel 340 is selectively configured to move with the tailgate 345. Tailgate 345 is configured to rotate about two points. Tailgate 345 can pivot downward into a position that is in line with the cargo bed 350. Tailgate 345 can also pivot with rear panel 340 toward top panel 310 about hinge 365 so that the tailgate is flush with respect to top panel, as shown. Top panel 310 includes an adjustable latch 405 to selectively secure the rear panel 340 and tailgate 345 therein. Latch 405 can be a sliding latch configured to adjust longitudinally to a shorter configuration when securing panel 340 therein and an elongated position when securing panel 340 and tailgate 345 therein. In another embodiment, side panels include latches (e.g., 325 and 335 as shown in FIGS. 7-8) to secure the rear panel 340 and tailgate 345 in an upward position. Tailgate 345 includes a switch 355 to enable selective engagement with hinge 365 or to enable upward pivoting. In the shown embodiment, hinges 380 and 365 are included in the side panels 320, 330. In another embodiment, side panels 320, 330 include a latch, similar to latch 405, to secure the rear panel 340 and tailgate 345 in the upward position.

The panels and panels of the cargo management systems can be configured to manually deploy or automatically deploy. In the shown embodiment, panels are composed of a polymer (or hard plastic). Panels are formed via injection molding. Panels can be formed, e.g., using foam/gas molding or other comparable forming techniques in the art.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the written description or claims are approximations that can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

It is noted that, as used in this specification and the appended claims, the singular forms “a”, “an,” and “the,” include plural referents unless expressly and unequivocally limited to one referent. Thus, for example, reference to “a panel” includes two or more different panels. As used herein, the term “include” and its grammatical variants are intended to be non-limiting, such that recitation of items in a list is not to the exclusion of other like items that can be substituted or added to the listed items.

It will be apparent to those skilled in the art that various modifications and variations can be made to the methodologies of the present disclosure without departing from the scope of its teachings. Other embodiments of the invention will be apparent to those skilled in the art from consideration of the specification and practice of the teachings disclosed herein. It is intended that the specification and examples be considered as exemplary only.

While the best modes for carrying out the invention have been described in detail, those familiar with the art to which this invention relates will recognize various alternative designs and embodiments for practicing the invention within the scope of the appended claims.

We claim:

1. A vehicle, comprising:
a cargo bed;
a tailgate at one end of the cargo bed, the tailgate configured to move between an opened position and a closed position; and
a cargo management system configured to pivot between a stowed position and an extended position, the system including:
a first panel configured to at least partially cover the cargo bed when the cargo management system is in the stowed position, thereby improving vehicle fuel efficiency;
wherein when in the stowed position the cargo management system at least partially sits atop the cargo bed;
wherein when in the extended position the cargo management system at least partially sits atop the tailgate.

2. The vehicle of claim 1, wherein the stowed position and extended position are separated by at least 120 degrees.

3. The vehicle of claim 1, wherein the first panel is fixed with respect to the cargo management system.

4. The vehicle of claim 1, wherein the cargo management system further comprises a second panel configured to pivot with the first panel.

5. The vehicle of claim 4, wherein the first panel is configured to pivot towards the second panel.

6. The vehicle of claim 4, wherein the cargo management system further comprises a third panel and a fourth panel configured to pivot with the first panel.

7. The vehicle of claim 6, wherein third panel and fourth panel are configured to rotate with respect to side panels of the cargo bed.

8. The vehicle of claim 7, wherein the third panel and fourth panel each include at least one rounded corner.

9. The vehicle of claim 8, wherein the rounded corner is rounded at least at a 30 degree angle.

10. A cargo management system for use with a vehicle having a cargo bed and tailgate, the system comprising:
a top panel configured to at least partially cover the cargo bed;
two side panels positioned between the cargo bed and top panel, side panels configured to attach to the top panel; and
a rear panel configured to selectively rotate with respect to the top panel;
wherein the cargo management system is configured to rotate between the cargo bed and the tailgate when the tailgate is down.

11. The system of claim 10, wherein the top panel includes a latch configured to selectively secure the rear panel to the top panel when the rear panel is rotated toward the top panel.

12. The system of claim 10, wherein the top panel is configured to pivot with respect to the rear panel.

13. The system of claim 12, wherein the top panel includes a locking mechanism.

14. The system of claim 12, wherein the rear panel includes a latch to secure top panel when rotated toward rear panel.

15. The system of claim 10, wherein the rear panel is configured to move with the tailgate.

16. The system of claim 15, wherein the top panel includes a latch configured to secure the rear panel and tailgate to the top panel.

17. The system of claim 15, wherein the side panels include a latch configured to secure the tailgate in an upward position.

18. The system of claim 10, wherein the side panels include at least one hinge to enable rear panel to rotate with respect to top panel.

19. The system of claim 10, wherein the side panels include a latch configured to secure the rear panel in an upward position.

20. The system of claim 10, wherein the system includes a latch enabling the system to be selectively removed from the cargo bed.
